(19) United States
(12) Patent Application Publication
(10) Pub. No.: US 2024/0097895 A1
(43) Pub. Date: Mar. 21, 2024

(54) DEVICE IDENTITY AUTHENTICATION METHOD AND APPARATUS, ELECTRONIC DEVICE, AND COMPUTER-READABLE MEDIUM

(71) Applicant: BOE Technology Group Co., Ltd., Beijing (CN)

(72) Inventors: Cheng LIU, Beijing (CN); Hongtao GUAN, Beijing (CN); Zhensheng BI, Beijing (CN)

(21) Appl. No.: 18/274,498

(22) PCT Filed: Oct. 28, 2021
(86) PCT No.: PCT/CN2021/126978

§ 371 Date: Jul. 27, 2023

(51) Int. Cl. H04L 9/08; G06F 21/44

(52) U.S. Cl. CPC H04L 9/088; G06F 21/44; H04L 9/0869

(57) ABSTRACT

This disclosure provides a device identity authentication method and apparatus, an electronic device, and a computer-readable medium. The device identity authentication method includes generating, by a terminal device, a first identity authentication message in response to an identity authentication instruction; sending the first identity authentication message to the second device for the second device to authenticate an identity of the terminal device based on the first identity authentication message to obtain a first identity authentication result; receiving, by the terminal device, a second identity authentication message; wherein the second identity authentication message is a message sent by the second device when the first identity authentication result is passed; authenticating an identity of the second device based on the second identity authentication message to obtain a second identity authentication result.

### TECHNICAL FIELD

This disclosure belongs to the field of computer technology and specifically relates to a device identity authentication method and a device identity authentication apparatus, an electronic device, and a computer-readable medium.

### BACKGROUND

A terminal device usually reserves a hardware interface (such as a USB interface or a serial port), through which an upper computer can send control instructions or read data from the terminal device, enabling development and maintenance technicians to debug, test, and maintain the terminal device. Due to an open nature of the hardware interface, the hardware interface affects the security of data transmission between the upper computer and terminal device.

### SUMMARY

The present disclosure provides a device identity authentication method and a device identity authentication apparatus, an electronic device, and a computer-readable medium.

A first aspect of the embodiments of the present disclosure provides a device identity authentication method applied to a terminal device, including:
generating, by the terminal device, a first identity authentication message in response to an identity authentication instruction; wherein the identity authentication instruction is an instruction initiated by a second device to authenticate an identity of the terminal device;
sending the first identity authentication message to the second device, for the second device to authenticate the identity of the terminal device based on the first identity authentication message, to obtain a first identity authentication result;
receiving, by the terminal device, a second identity authentication message; wherein the second identity authentication message is a message sent by the second device when the first identity authentication result is passed;
authenticating an identity of the second device based on the second identity authentication message, to obtain a second identity authentication result.

Wherein the first identity authentication message includes a first random number, an identifier of the terminal device, and first signature data; wherein the first random number is generated by the terminal device, and the first signature data is obtained by signing the first random number using a private key of the terminal device and through a pre agreed signature algorithm.

Wherein generating a first identity authentication message in response to an identity authentication instruction including:
generating, by the terminal device, the first random number in response to the identity authentication instruction;
signing the first random number using the private key of the terminal device and through a pre agreed signature algorithm, to obtain the first signature data;
obtaining the first identity authentication message based on the first random number, the identifier of the terminal device, and the first signature data.

Wherein the second identity authentication message includes second signature data obtained by signing the first random number using a private key of the second device and through the signature algorithm.

Wherein authenticating an identity of the second device based on the second identity authentication message to obtain a second identity authentication result including:
authenticating the second signature data using a public key of the second device and through an authentication algorithm to obtain the second identity authentication result.

Wherein the signature algorithm includes either an ECDSA algorithm or an RSA algorithm.

Wherein after obtaining the second identity authentication result, the method further includes:
when the second identity authentication result is authentication passed, returning a second identity authentication result to the second device.

Wherein after obtaining the second identity authentication result, the method further includes:
when the second identity authentication result is authentication passed, entering, by the terminal device a credit mode; and/or,
when the second identity authentication result is authentication failed, generating, recording, and/or sending an alarm message.

Wherein after the terminal device entering a credit mode, the method further includes:
cyclically monitoring a number of effective communications within a preset time period;
exiting from the credit mode when the number of effective communications is less than the preset threshold.

Wherein after the terminal device entering a credit mode, the method further includes:
monitoring a connection status between the terminal device and the second device;
when the connection status is disconnected, exiting from the credit mode.

Wherein the terminal device and the second device are connected through a cable;
when the connection state is disconnected, exiting from the credit mode includes:
exiting from the credit mode when the cable is disconnected from the terminal device and/or the second device.

A second aspect of the embodiments of the present disclosure provides a device identity authentication method applied to an upper computer, including:
sending, by the upper computer, an identity authentication instruction to a first device;
receiving a first identity authentication message returned by the first device; wherein the first identity authentication message is information generated by the first device in response to the identity authentication instruction;
authenticating an identity of the first device based on the first identity authentication message, to obtain a first identity authentication result;
when the first identity authentication result is passed, sending a second identity authentication message to the first device for the first device to authenticate an identity of the upper computer based on the second identity authentication message, to obtain the second identity authentication result.

Wherein the first identity authentication message includes a first random number, an identifier of the first device, and first signature data; wherein the first random number is generated by the first device, and the first signature data is obtained by signing the first random number using a private key of the first device and through a pre agreed signature algorithm.

Wherein authenticating an identity of the first device based on the first identity authentication message to obtain a first identity authentication result including:
obtaining a public key of the first device based on the identifier of the first device;
wherein the private key of the first device and the public key of the first device are identity keys of the first device;
authenticating the first signature data using the public key of the first device and through the signature algorithm, to obtain the first identity authentication result.

Wherein the second identity authentication message includes second signature data obtained by signing the first random number using a private key of the upper computer and through a predetermined signature algorithm.

Wherein the signature algorithm includes either an ECDSA algorithm or an RSA algorithm.

Wherein the first device is authenticated based on the first identity authentication message, and after obtaining the first identity authentication result, the method further includes:

when the first identity authentication result is failed, terminating the identity authentication process.

Wherein after sending a second identity authentication message to the first device, the method further includes:
receiving the second identity authentication result returned by the first device.

Wherein after sending a second identity authentication message to the first device, the method further includes:
receiving a message of entering a credit mode sent by the first device; wherein the first device enters the credit mode when the second identity authentication result is passed.

Wherein after receiving a message of entering a credit mode sent by the first device, the method further includes:
receiving a message of exiting from the credit mode sent by the first device;
wherein the first device sends a message of exiting from the credit mode when a number of effective communications within a preset time period is lower than a preset threshold, or the upper computer sends a message of exiting from the credit mode when the upper computer is disconnected from the first device.

A third aspect of the embodiments of the present disclosure provides a device identity authentication apparatus, including:
a first generation module configured to generate a first identity authentication message in response to an identity authentication instruction; wherein the identity authentication instruction is an instruction initiated by a second device to authenticate an identity of the terminal device;
a first transmission module configured to send the first identity authentication message to the second device, for the second device to authenticate the identity of the terminal device based on the first identity authentication message, to obtain a first identity authentication result;
a first receiving module configured to receive a second identity authentication message; wherein the second identity authentication message is a message sent by the second device when the first identity authentication result is passed;
a first authentication module configured to authenticate an identity of the second device based on the second identity authentication message, to obtain a second identity authentication result.

A fourth aspect of the embodiments of the present disclosure provides a device identity authentication apparatus, including:
a second transmission module configured to send an identity authentication instruction to the first device;
a second receiving module configured to receive a first identity authentication message returned by the first device; wherein the first identity authentication message is information generated by the first device in response to the identity authentication instruction;
a second authentication module configured to authenticate an identity of the first device based on the first identity authentication message, to obtain a first identity authentication result;
the second transmission module further configured to, when the first identity authentication result is passed, send a second identity authentication message to the first device for the first device to authenticate an identity of the terminal device based on the second identity authentication message, to obtain the second identity authentication result.

A fifth aspect of the embodiments of the present disclosure provides a n electronic device including:
one or more processors;
a storage device on which one or more programs are stored, when the one or more programs are executed by the one or more processors, such that the one or more processors implement any of the methods according to the first aspect;
one or more I/O interfaces connected between the processor and the memory, configured to implement information exchange between the processor and the memory.

A six aspect of the embodiments of the present disclosure provides a computer-readable medium on which a computer program is stored, and when the program is executed by a processor, any of the methods according to the first aspect is implemented.

### BRIEF DESCRIPTION OF THE DRAWINGS

FIG. 1 is diagram illustrating an application scene of embodiments of the present disclosure;

FIG. 2 is a flowchart of a device identity authentication method according to embodiments of the present disclosure;

FIG. 3 is a flowchart for generating first identity authentication message according to embodiments of the present disclosure;

FIG. 4 is a flowchart of a current device entering a credit mode according to embodiments of the present disclosure;

FIG. 5 is a flowchart of a device identity authentication method according to embodiments of the present disclosure;

FIG. 6 is a schematic diagram of a device identity authentication apparatus according to embodiments of the present disclosure;

FIG. 7 is a schematic diagram of a device identity authentication apparatus according to embodiments of the present disclosure;

FIG. 8 is a flowchart of bidirectional identity authentication between an upper computer and a terminal device according to embodiments of the present disclosure;

FIG. 9 provides a schematic diagram of an electronic device according to embodiments of the present disclosure.

Reference numerals: 101: upper computer; 102: terminal device; 103: cable; 104: hardware interface; 105: operation control module; 106: secure storage module; 601: first generation module; 602: first transmission module; 603: first receiving module; 604: first authentication module; 701: second transmission module; 702: second receiving module; 703: second authentication module; 901: processor; 902: memory; 903: I/O interface.

### DETAILED DESCRIPTION OF THE EMBODIMENTS

In order to enable those skilled in the art to better understand the technical solution of the present disclosure/utility model, the following is a further detailed description of the present disclosure/utility model in conjunction with the accompanying drawings and specific implementations.

Unless otherwise defined, technical or scientific terms used in this disclosure shall have the usual meaning understood by individuals with general skills in the field to which this disclosure belongs. The terms “first”, “second”, and similar terms used in this disclosure do not indicate any order, quantity, or importance, but are only used to distinguish different components. Similarly, similar words such as “a”, “an”, or “the” do not indicate a quantity limit, but rather indicate the existence of at least one. Words such as “comprising” or “including” refer to the components or objects that appear before the word, including the components or objects listed after the word and their equivalents, without excluding other components or objects. Words such as “connected” or “connection” are not limited to physical or mechanical connections, but can include electrical connections, whether direct or indirect. The terms “up”, “down”, “left”, “right”, etc. are only used to represent relative positional relationships. When the absolute position of the described object changes, the relative positional relationship may also change accordingly.

After establishing a connection between the upper computer and the terminal device, in order to improve the security of data transmission and control instructions, and to avoid the terminal device from executing illegitimate upper computer control instructions, it is necessary to authenticate the identity of the upper computer before the terminal device transmits data with the upper computer and executes control instructions from the upper computer. However, in the actual operation process, if the illegitimate terminal device is connected to the upper computer, the communication information of the upper computer can be decoded, which tends to damage the communication mechanism of the upper computer and lead to replay attack. However, in the related art, there is no bidirectional authentication mechanism between terminal devices and upper computers. Due to the lack of a bidirectional authentication mechanism between upper computers and terminal devices, if an intermediate device (or an intermediate party) is inserted between the upper computer and the terminal device and replaces information transmitted in between with its own information, an intermediate bidirectional attack can occur.

In some cases, due to the limited computing power of the terminal device, if the terminal device authenticates each control instruction from the upper computer, it will not only consume a large number of resources of the terminal device, such as electrical energy resources, but also reduce communication speed.

Therefore, embodiments of the present disclosure provide a bidirectional authentication mechanism to achieve bidirectional authentication between the upper computer and the terminal device, thereby improving the security of communication between the upper computer and the terminal device.

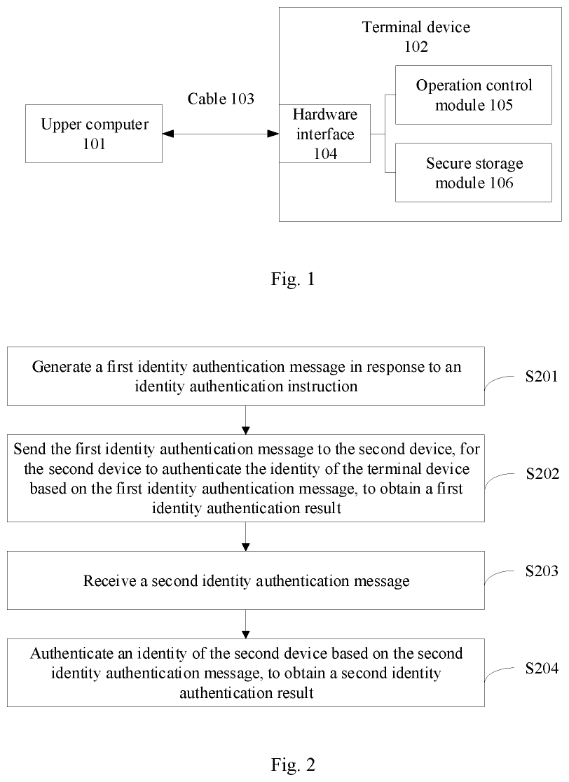

FIG. 1 is diagram illustrating an application scene of embodiments of the present disclosure. As shown in FIG. 1, the system includes an upper computer 101 and a terminal device 102. The terminal device 102 is provided with a hardware interface 104, and the hardware interface 104 can be connected to a cable 103. The terminal device 102 is connected to the upper computer 101 through the cable 103, and control commands and data between the upper computer 101 and the terminal device 102 are transmitted through the cable 103.

The upper computer 101 is configured with an operating system and a first application program, and the operating system is configured to run the first application program and implement regular operations of the upper computer 101. The first application program can be configured to control the terminal device 102 and implement control of the terminal device 102. The terminal device 102 is configured with a second application program, and the second application program is configured to respond to the operation of the upper computer 101 and execute control instructions of the upper computer 101.

The terminal device 102 is provided with a operation control module 105 and a secure storage module 106, wherein the operation control module 105 is configured to control the terminal device 102. The controller 105 can operate a processor, such as a microcontroller, System on a Chip (SoC), or Field Programmable Gate Array (FPGA). The secure storage module 106 is configured to store data of the terminal device 102, such as an identifier and an identity key of the terminal device 102. The data stored in the secure storage module 106 can only be read by a program burned and recorded in the operation control module 105, avoiding being read by other external devices and improving the data security of the terminal device 102. In some embodiments, the operation control module 105 and the secure storage module 106 may be two independent components installed in the terminal device 102, or they may be one component, that is, the operation control module 105 and the secure storage module 106 are integrated into one chip.

The hardware interface 104 can use a USB interface or a serial port. When the hardware interface 104 is a USB interface, the cable 103 uses a USB cable. When the hardware interface 104 is a serial port, the cable 103 uses a serial port cable. Moreover, the hardware interface 104 has a plug-unplug monitoring function, which can determine the plug-unplug status of the hardware interface 104 based on monitoring signals.

The cable 103 is usually under monitoring, ensuring that it only connects to the upper computer 101 and terminal device 102, and does not connect to other devices. Although it can ensure that the cable 103 does not connect to other devices when under monitoring, this does not mean that the cable 103 can freely connect to other devices when not under monitoring. In fact, some monitoring devices can be configured to ensure that the cable 103 is not connected to other devices. Monitoring the cable 103 or keeping the cable 103 under user control can prevent attacks from intermediate devices.

Firstly, embodiments of the present disclosure provide a device identity authentication method that can implement bidirectional identity authentication between a first device and a second device, thereby improving security of data transmission between the first device and the second device. The first device can be a terminal device, and the second device can be an upper computer. Alternatively, the first device can be an upper computer, and the second device can be a terminal device.

For ease of understanding, the following embodiments will be described taking the terminal device as the first device and the upper computer as the second device.

As shown in FIG. 2, the device identity authentication method according to embodiments of the present disclosure can be applied to a first device, which includes the following steps.

In step S201, a first identity authentication message is generated in response to an identity authentication instruction.

Here, the identity authentication instruction is an instruction initiated by the second device to authenticate an identity of the current device. The current device and the second device intend to establish a communication connection, and identity authentication is required before data transmission between the current device and the second device.

In some embodiments, the second device sends an identity authentication instruction to the first device upon detecting a hardware connection between the first device and the second device. Alternatively, the second device can actively send an identity authentication instruction to the first device when a preset requirement is met.

In step S202, the first identity authentication message is sent to the second device for the second device to authenticate the identity of the current device based on the first identity authentication message, to obtain a first identity authentication result.

Here, the first identity authentication message includes information required for the second device to authenticate the identity of the current device. In some embodiments, the first identity authentication message includes a first random number, an identifier of the current device, and first signature data. Here, the first random number is generated by the current device, and the identifier of the current device is a unique identifier of the current device identity. The current device and the identifier have a one-to-one correspondence, and the device can be determined from the identifier.

The first signature data is obtained by signing the first random number using a private key of the current device and through a pre agreed signature algorithm.

It should be noted that the current device has an identity key, and the identity key includes a public key of the current device and a private key of the current device. The private key of the current device is stored in the current device and used for signing a hash value of to-be-transmitted information. The public key of the current device is informed to the peer device, that is, the second device. The second device uses the public key of the current device to authenticate the hash value of the to-be-transmitted information. After authentication, it indicates that the received data is signed using the private key of the current device, indicating that the data is intact and has not been tampered with.

The signature algorithm is a pre agreed algorithm between the current device and the second device. The signature algorithm includes either the ECDSA algorithm or the RSA algorithm, and other algorithms suitable for encrypting data can also be used. Here, the ECDSA algorithm has better security performance while consuming less computational power.

In this embodiment, the signature process through the ECDSA algorithm includes: generating a random number d, and calculating the random number through the ECC algorithm to obtain another random number r; performing a hash operation on the to-be-sent data to obtain a hash value H; based on the random number d, the random number r, and the hash value H, calculating a value s through the ECC algorithm again, and (r, s) is the signature data. The process of authentication through the ECDSA algorithm includes authenticating whether the random number r and the value s are legitimate, calculating a hash value H of the received data, and calculating a value v through the ECC algorithm based on the hash value H and the value s. If the value v is equal to the random number r, the authentication is passed; otherwise, the authentication fails. The ECDSA algorithm has a signature length of 256 bit, combined with a SHA-256 algorithm, a hash value of the to-be-signed data can be calculated.

It should be noted that the process of signature and authentication through the ECDSA algorithm is only for the convenience of understanding, and does not represent a limitation on the signature and authentication method.

In step S203, a second identity authentication message is received.

Here, the second identity authentication message is a message sent by the second device when the first identity authentication result is passed. The second identity authentication message is a message used to authenticate the identity of the second device. The first identity authentication result includes two situations: passed and failed. Passed refers to the situation where the second device authenticates the current device as a legitimate device based on the first identity authentication message, and failed refers to the situation where the second device authenticates the current device as an illegitimate device based on the first identity authentication message.

In some embodiments, the second identity authentication message includes second signature data, and the second signature data is data obtained by the second device signing the first random number through a signature algorithm using a private key of the second device.

It should be noted that after the current device and the second device pre agreed on a signature algorithm, both the current device and the second device use the signature algorithm to sign the data to obtain signature data, or to authenticate a signature data. That is, during a bidirectional authentication process, the current device and the second device need to ensure the consistency of the signature algorithm.

In step S204, the identity of the second device is authenticated based on the second identity authentication message to obtain a second identity authentication result.

In step S204, the current device authenticates the identity of the second device through a second identity authentication message. Here, the second identity authentication result includes two situations: passed and failed. Passed refers to the situation where the current device authenticates the second device as a legitimate device based on the second identity authentication message, and failed refers to the situation where the current device authenticates the second device as an illegitimate device based on the second identity authentication message.

In some embodiments, the current device authenticates the second signature data using a public key of the second device and through the authentication algorithm to obtain the second identity authentication result.

Here, the public key of the second device and the private key of the second device are the identity keys of the second device. The private key of the second device is stored in the second device and strictly confidential in order to avoid exposure. The private key of the second device is used to encrypt the data to be transmitted. The public key of the second device is stored in the current device, and usually the public key of the second device is burned in the current device.

In the case where both the first and second identity authentication results are passed, that is, both the current device and the second device successfully authenticate the identity of the other party, and then the current device and the second device can securely transmit data to each other.

In embodiments of the present disclosure, the current device generates a first identity authentication message in response to an identity authentication instruction to enable the second device to authenticate the identity of the current device based on the first identity authentication message. The second device sends a second identity authentication message to the current device to enable the current device to authenticate the identity of the current device based on the second identity authentication message, thus achieving bidirectional identity authentication between the current device and the second device, avoiding access from illegitimate terminal devices.

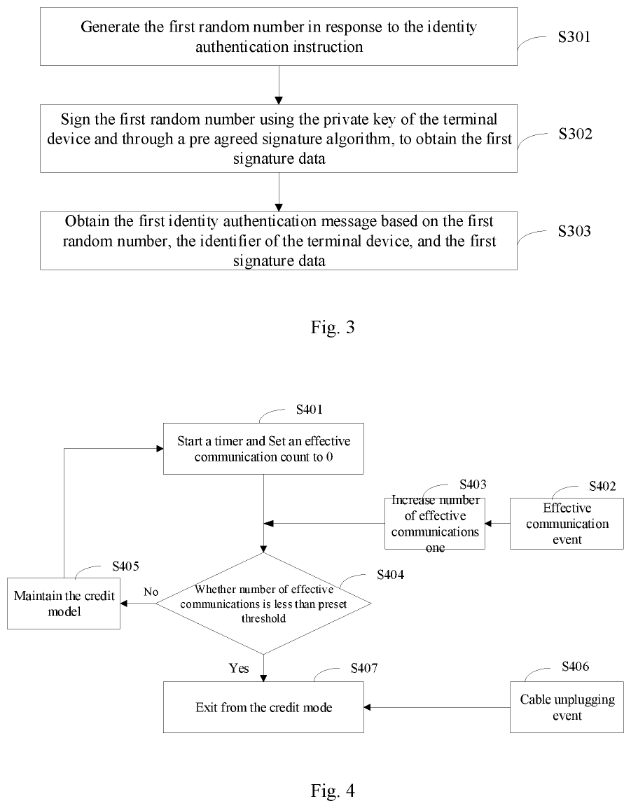

As shown in FIG. 3, generating a first identity authentication message in response to an identity authentication instruction, including the following steps.

In step S301, a first random number is generated in response to the identity authentication instruction.

Here, the first random number is a value generated by the current device, and the generation method of the first random number can be implemented by an existing random number generator or related software, which is not limited by the embodiments of the disclosure.

In step S302, the first random number is signed through a pre agreed signature algorithm using the private key of the current device, to obtain a first signature data.

Here, the private key of the current device is stored in the current device and strictly confidential in order to avoid exposure. A signature algorithm is used to sign the first random number and obtain the first signature data.

In step S303, the first identity authentication message is obtained based on the first random number, the identifier of the current device, and the first signature data.

With embodiments of the present disclosure, by using the first random number and signing the first random number, it can reduce encryption complexity and resource consumption, prevent replay attack in a simple and low-power way, while is less difficult to produce and maintain, compared with the existing technology of “one machine, one key” and “dynamic key”.

In some embodiments, after step S204, the method also includes returning a second identity authentication result to the second device if the second identity authentication result is authenticated as passed. In the case where the second identity authentication result is passed, the current device terminates the identity authentication process to save network resources between the current device and the second device, and the resources of the current device and the second device per se.

In some embodiments, in the case where the second identity authentication result is failed, a message can also be returned to the second device, that is, a message indicating that the identity authentication is not passed.

In some embodiments, after step S204, the method also includes: if the second identity authentication result is passed, the current device enters a credit mode, and a message of the current device entering the credit mode can be sent to the second device.

Here, the credit mode also refers to a trust mode. Before the current device enters the credit mode, the identity authentication of the current device and the second device is not completed, and data transmission is not secure. Only when the current device enters the credit mode, it indicates that the identity authentication of the current device and the second device is complete, and the data transmission is secure and reliable.

In some embodiments, after the current device obtains the second identity authentication result, it does not return the second identity authentication result to the second device immediately. Instead, it waits for the current device to enter the credit mode and returns a message to the second device. This message can include the second identity authentication result and information about the current device entering the credit mode, or it can only include information about the current device entering the credit mode. The second device can determine that the second identity authentication result is passed from the information about the current device entering the credit mode.

In some embodiments, after step S204, the method also includes: in the event that the second identity authentication result is authentication failed, generating alarm information, recording and/or sending alarm information, and ending the identity authentication process. Here, the alarm information can be sent to a monitoring center of the system to facilitate a user to timely understand the security status of the system.

In the case where the signature data fails to pass the authentication of the current device or the first device, or the second device receives an illegitimate identifier, or the second device is unable to obtain the public key of the private key of the terminal identity, the identity authentication process ends and an alert message is recorded and/or sent out.

In some embodiments, after step S204, the method also includes: if the second identity authentication result is passed, the current device enters the credit mode, and a message that the current device enters the credit mode can be sent to the second device. If the second identity authentication result is failed, an alarm message is generated and the alarm message is recorded and/or sent out.

In some embodiments, after the current device enters the credit mode, the method also includes: cyclically monitoring a number of effective communications within a preset time period; and exiting from the credit mode when the number of effective communications is less than a preset threshold.

Here, the preset threshold can be set by the user, usually set to 1. When the number of effective communications is less than 1, the current terminal exits from the credit mode.

For example, after the current device enters the credit mode, a timer is started to record the monitoring time, and the initial value of the timer is 0. The time for cyclic monitoring can be set by the user, such as 30 seconds, which means one cycle every 30 seconds. If the number of effective communications is less than 1 within a cyclic monitoring cycle, the current device will exit from the credit mode. Here, timers are a commonly known technology in the field of embedded technology, and embodiments of the present disclosure does not limit timers.

In some embodiments, after the current device enters the credit mode, the method also includes: monitoring the connection status between the current device and the second device; and exiting from the credit mode when the connection status is disconnected.

The connection status of the current device and the second device can be monitored with suitable methods in the related art, and embodiments of the present disclosure does not limit the method for monitoring the connection status.

In embodiments of the present disclosure, after the current device enters the credit mode, if the second device does not transmit data with the current device for a long time, and if the second device does not issue control instructions to the current device, it exits from the credit mode. This can not only avoid the current device from improperly stopping in the credit mode, but also improve the communication efficiency between the current device and the second device, reducing resource consumption.

In some embodiments, the current device and the second device are connected via a cable, which should be understood as a wired manner, that is, the current device and the second device are connected in a wired manner.

When the connection status is disconnected, exiting from the credit mode includes: when the connection between the cable and the current device and/or the second device is disconnected, exiting from the credit mode, for example, when the cable is disconnected from the current device, exiting from the credit mode; alternatively, when the cable is disconnected from the second device, exiting from the credit mode; alternatively, when the cable is disconnected from both the current device and the second device, exiting from the credit mode. It should be noted that when the cable is unplugged, it can disconnect the cable from the current device and the second device. The system can monitor the connection status between the cable and the current device and the second device through interruption or polling manner.

In embodiments of the present disclosure, whether the current device is in the credit mode can be determined by monitoring the effective communication and the cable connection status between the current device and the second device. This can avoid duplicate identity authentication without reducing the security of the current device and the second device.

In embodiments of the present disclosure, the terminal device 102 can be an IoT terminal device or other lower devices.

As shown in FIG. 4, after the current device enters the credit mode, the method includes the following steps.

In step S401, a timer is started and an effective communication count is set to 0.

After the current device enters the credit mode, the timer is started and the effective communication count is set to 0. In embodiments of the present disclosure, at the end of each cycle, the effective communication count must be set to 0 to re count.

In step S402, an effective communication event is obtained.

The method for determining an effective communication event can be determined according to existing methods, and embodiments of the present disclosure does not limit this.

In step S403, the number of effective communications is increased by one.

In step S403, the number of effective communications can be counted using an accumulator.

In step S404, when the timer reaches a preset time, whether the number of effective communications is less than the preset threshold is determined. If the number of effective communications is greater than or equal to the preset threshold, step S405 is performed; if the number of effective communications is less than the preset threshold, it proceeds to step S407.

In step S405, the credit model is maintained.

In step S406, cable unplugging event. If the connection status of the cable is disconnected, step S407 is performed.

In step S407, exit from the credit mode.

In embodiments of the present disclosure, the current device can be an IoT terminal device or other lower devices.

In a second aspect, embodiments of the present disclosure provides a device identity authentication method that can achieve bidirectional identity authentication between the first device and the second device, thereby improving the security of data transmission between the first device and the second device.

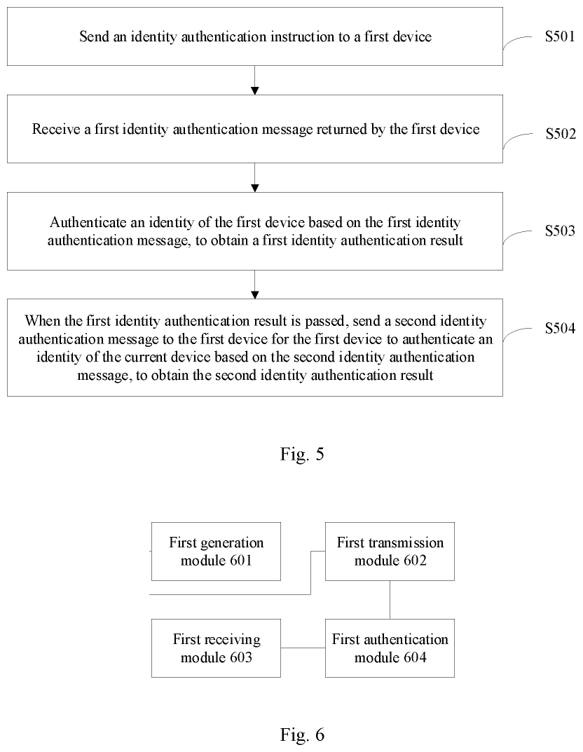

As shown in FIG. 5, the device identity authentication method according to embodiments of the present disclosure can be applied to a second device, which includes the following steps.

In step S501, an identity authentication instruction is sent to the first device.

Here, the identity authentication instruction is the instruction initiated by the current device to authenticate the identity of the first device. The current device and the first device intend to establish a communication connection, and identity authentication needs to be completed before data transmission between the current device and the first device.

In some embodiments, the current device sends an identity authentication instruction to the first device upon detecting a hardware connection between the first device and the current device. Alternatively, the current device can actively send an identity authentication instruction to the first device when a preset requirement is met.

In step S502, a first identity authentication message returned by the first device is received.

Here, the first identity authentication message is information generated by the first device in response to the identity authentication instruction, including the information required for the current device to authenticate the first device. In some embodiments, the first identity authentication message includes a first random number, an identifier of the first device, and first signature data. Here, the first random number is generated by the first device, and the generation method of the first random number can be implemented by an existing random number generator or related software, which is not limited by the embodiments of the present disclosure.

The identifier of the first device is a unique identifier of the first device identity, and the first device and the identifier have a one-to-one correspondence, which can be used to determine the first device.

The first signature data is obtained by signing the first random number using the private key of the first device and through a pre agreed signature algorithm.

It should be noted that the first device has an identity key, and the identity key includes a public key of the first device and a private key of the first device. The private key of the first device is stored in the first device and used for signing a hash value of to-be-transmitted information. The public key of the first device is informed to the peer device, that is, the current device. The current device uses the public key of the first device and the hash value of the information to be transmitted for authentication. After authentication, it indicates that the received data is signed using the private key of the first device, indicating that the data is intact and has not been tampered with.

The signature algorithm is a pre agreed algorithm between the first device and the current device. The signature algorithm includes either the ECDSA algorithm or the RSA algorithm, and other algorithms suitable for encrypting data can also be used.

With the embodiments of the present disclosure, by using the first random number and signing the first random number, it can reduce encryption complexity and resource consumption, and prevent replay attack in a simple and low-power way, compared with the existing technology of “one machine, one key” and “dynamic key”.

In step S503, the identity of the first device is authenticated based on the first identity authentication message, to obtain a first identity authentication result.

The current device authenticates the identity of the first device through the first identity authentication message. The first identity authentication result includes two situations: passed and failed. Passed refers to the situation where the current device authenticates the first device as a legitimate device based on the first identity authentication message, and failed refers to the situation where the current device authenticates the first device as an illegitimate device based on the first identity authentication message.

In some embodiments, the current device can simultaneously connect to a plurality of first devices and obtain the public key of each first device through an identifier-identity key to authenticate the legitimacy of the first device.

Authenticating the identity of the first device based on the first identity authentication message to obtain the first identity authentication result, including: obtaining a public key of the first device based on the identifier of the first device. Here, the private key of the first device and the public key of the first device are identity keys of the first device; authenticating the first signature data using the public key of the first device and through a signature algorithm to obtain the first identity authentication result.

Here, the public key of the first device and the private key of the first device are the identity keys of the first device. The private key of the first device is stored in the first device and strictly confidential in order to avoid exposure. The private key of the first device is used to encrypt the to-be-transmitted data.

In step S504, in the case where the first identity authentication result is passed, a second identity authentication message is sent to the first device for the first device to authenticate the identity of the current device based on the second identity authentication message, to obtain a second identity authentication result.

In some embodiments, the second identity authentication message includes second signature data, and the second signature data is data obtained by signing the first random number using the private key of the current device and through a predetermined signature algorithm.

Here, the second identity authentication result includes two situations: passed and failed. Passed refers to the situation where the current device authenticates the second device as a legitimate device based on the second identity authentication message, and failed refers to the situation where the current device authenticates the second device as an illegitimate device based on the second identity authentication message.

In the case where both the first and second identity authentication results are passed, that is, both the current device and the first device successfully authenticate the identity of the other party, and then the current device and the first device can securely transmit data.

In embodiments of the present disclosure, the current device sends an identity authentication instruction to the first device and authenticates the identity of the first device based on the first identity authentication message returned by the first device. If the first identity authentication result is passed, a second identity authentication message is sent to the first device for the first device to authenticate the identity of the current device based on the second identity authentication message, thus realizing bidirectional identity authentication between the current device and the first device, avoiding illegitimate terminal device access.

In some embodiments, the identity of the first device is authenticated based on the first identity authentication message, and after obtaining the first identity authentication result, the method also includes terminating the identity authentication process if the first identity authentication result is failed.

If the current device determines that the first identity authentication result is failed, terminating the identity authentication process in a timely manner can save network resources between the current device and the first device, and the resources of the current device and the first device per se.

In some embodiments, after sending a second identity authentication message to the first device, the method also includes receiving a second identity authentication result returned by the first device, and the current device obtaining an authentication result on its own identity from the first device.

In some embodiments, after sending a second identity authentication message to the first device, the method also includes: receiving a message of entering the credit mode sent by the first device. Here, the first device enters the credit mode when the second identity authentication result is passed.

In some embodiments, after receiving the message of entering the credit mode sent by the first device, the method also includes: receiving a message of exiting from the credit mode sent by the first device. Here, the first device sends a message of exiting from the credit mode when a number of effective communications within a preset time period is lower than a preset threshold, or sends a message of exiting from the credit mode when the current device is disconnected from the first device.

After the first device enters the credit mode, the first device cyclically monitors the number of effective communications within a preset time period. When the number of effective communications is less than the preset threshold, the first device exits from the credit mode and sends to the current device a message of the first device exiting from the credit mode.

The number of effective communications and the counting method thereof are described in detail in the above embodiments and will not be further elaborated here.

In some embodiments, after the first device enters the credit mode, the connection status between the first device and the current device is monitored; the first device exits from the credit mode when the connection status is disconnected.

In some embodiments, the first device and the current device are connected through a cable, and the cable here should be understood as a wired manner, that is, the first device and the current device are connected in a wired manner, for example, when the cable is disconnected from the first device, exiting from the credit mode; alternatively, when the cable is disconnected from the current device, exiting from the credit mode; alternatively, when the cable is disconnected from both the current device and the first device, exiting from the credit mode. It should be noted that when the cable is unplugged, it can disconnect the cable from the current device and the first device.

In embodiments of the present disclosure, whether the current device is in the credit mode can be determined by monitoring the effective communication and the cable connection status between the current device and the first device. This can avoid duplicate identity authentication without reducing the security of the current device and the first device.

In a third aspect, embodiments of the present disclosure provide a device identity authentication apparatus that can be configured to achieve bidirectional identity authentication between a first device and a second device, thereby improving the security of data transmission between the first device and the second device.

As shown in FIG. 6, the device identity authentication apparatus according to embodiments of the present disclosure can be applied to a first device, including the following components.

A first generation module 601 is configured to generate a first identity authentication message in response to identity authentication instructions.

Here, the identity authentication instruction is an instruction initiated by the second device to authenticate an identity of the current device. The current device and the second device intend to establish a communication connection, and identity authentication is required before data transmission between the current device and the second device.

In some embodiments, the second device sends an identity authentication instruction to the current device upon detecting a hardware connection between the current device and the second device. Alternatively, the second device can actively send an identity authentication instruction to the current device when a preset requirement is met.

A first transmission module 602 is configured to send the first identity authentication message to the second device for the second device to authenticate the identity of the current device based on the first identity authentication message, to obtain a first identity authentication result.

Here, the first identity authentication message includes information required for the second device to authenticate the identity of the current device. In some embodiments, the first identity authentication message includes a first random number, an identifier of the current device, and first signature data. Here, the first random number is generated by the current device, and the identifier of the current device is a unique identifier of the current device identity. The current device and identifier have a one-to-one correspondence, and the current device can be determined from the identifier.

The first signature data is obtained by signing the first random number using a private key of the current device and through a pre agreed signature algorithm.

The signature algorithm is a pre agreed algorithm between the current device and the second device. The signature algorithm includes either the ECDSA algorithm or the RSA algorithm, and other algorithms suitable for encrypting data can also be used.

A first receiving module 603 is configured to receive a second identity authentication message.

Here, the second identity authentication message is a message sent by the second device when the first identity authentication result is passed. The second identity authentication message is a message used to authenticate the identity of the second device. The first identity authentication result includes two situations: passed and failed. Pass refers to the situation where the second device authenticates the current device as a legitimate device based on the first identity authentication message, and failed refers to the situation where the second device authenticates the current device as an illegitimate device based on the first identity authentication message.

In some embodiments, the second identity authentication message includes second signature data, the second signature data is data obtained by the second device signing the first random number through a signature algorithm using a private key of the second device.

A first authentication module 604 is configured to authenticate the identity of the second device based on the second identity authentication message to obtain a second identity authentication result.

In some embodiments, the current device authenticates the second signature data using a public key of the second device and through the authentication algorithm to obtain the second identity authentication result.

In some embodiments, the first generation module 601 is configured to implement the following steps: generating a first random number in response to the identity authentication instruction; signing the first random number using the private key of the current device and through a pre agreed signature algorithm, to obtain the first signature data; obtaining the first identity authentication message based on the first random number, the identifier of the current device, and the first signature data.

Here, the first random number is a value generated by the current device, and the generation method of the first random number can be implemented by an existing random number generator or related software, which is not limited by the embodiments of the disclosure.

In some embodiments, in the case where the second identity authentication result is failed, the first authentication module 604 may also return a message to the second device, that is, a message indicating that the identity authentication is not passed.

In some embodiments, when the second identity authentication result is passed, the current device enters the credit mode, the device identity authentication apparatus may also send through the first transmission module 602 to the second device a message of the current device entering the credit mode.

In some embodiments, the device identity authentication apparatus also includes an alarm module (not shown in the FIG.), configured to, in the event that the second identity authentication result is authentication failed, generate alarm information, recording and/or sending alarm information. Here, the alarm information can be sent to a monitoring center of the system to facilitate a user to timely understand the security status of the system.

In some embodiments, the device identity authentication apparatus also includes a monitoring module (not shown in the FIG.) configured to cyclically monitor a number of effective communications within a preset time period; and exiting from the credit mode when the number of effective communications is less than a preset threshold.

When the current device and the second device are connected through a cable, the monitoring module can also be configured to monitor the connection status of the current device and the second device; and exit from the credit mode when the connection status is disconnected.

In embodiments of the present disclosure, whether the current device is in the credit mode can be determined by monitoring the effective communication and the cable connection status between the current device and the second device. This can avoid duplicate identity authentication without reducing the security of the current device and the second device.

In some embodiments of the present disclosure, the apparatus provided by the present disclosure have functions or modules that can be configured to perform the method described in the above method embodiments. The specific implementation and technical effects can be referred to in the first aspect of the method described in the above. For simplicity, this will not be repeated here.

The device identity authentication apparatus according to embodiments of the present disclosure, wherein the first generation module generates a first identity authentication message in response to the identity authentication instruction, the first transmission module sends the first identity authentication message to the second device to enable the second device to authenticate the identity of the current device based on the first identity authentication message, and the first receiving module receives the second identity authentication message, the first authentication module authenticates the identity of the current device based on the second identity authentication message, achieving bidirectional identity authentication between the current device and the second device, avoiding illegitimate terminal device access.

In a fourth aspect, embodiments of the present disclosure provide a device identity authentication apparatus that can be used to achieve bidirectional identity authentication between the first device and the second device, thereby improving the security of data transmission between the first device and the second device.

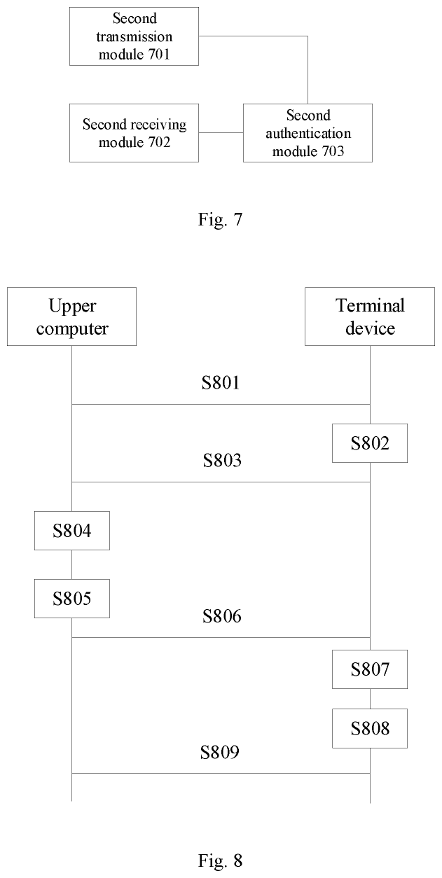

As shown in FIG. 7, the device identity authentication apparatus according to the embodiments of the present disclosure can be applied to a second device, including the following components.

A second transmission module 701 is configured to send an identity authentication instruction to the first device.

Here, the identity authentication instruction is the instruction initiated by the current device to authenticate the identity of the first device. The current device and the first device intend to establish a communication connection, and identity authentication needs to be completed before data transmission between the current device and the first device.

In some embodiments, the current device sends an identity authentication instruction to the first device upon detecting a hardware connection between the first device and the current device. Alternatively, the current device can actively send an identity authentication instruction to the first device when a preset requirement is met.

A second receiving module 702 is configured to receive a first identity authentication message returned by the first device.

Here, the first identity authentication message is information generated by the first device in response to the identity authentication instruction, including the information required for the current device to authenticate the first device. In some embodiments, the first identity authentication message includes a first random number, an identifier of the first device, and first signature data. Here, the first random number is generated by the first device, and the generation method of the first random number can be implemented by an existing random number generator or related software, which is not limited by the embodiments of the present disclosure.

The identifier of the first device is a unique identifier of the first device identity, and the first device and the identifier have a one-to-one correspondence, which can be used to determine the first device.

The first signature data is obtained by signing the first random number using the private key of the first device and through a pre agreed signature algorithm.

The signature algorithm is a pre agreed algorithm between the first device and the current device. The signature algorithm includes either the ECDSA algorithm or the RSA algorithm, and other algorithms suitable for encrypting data can also be used.

With the embodiments of the present disclosure, by using the first random number and signing the first random number, it can reduce encryption complexity and resource consumption, and prevent replay attack in a simple and low-power way, compared with the existing technology of “one machine, one key” and “dynamic key”.

A second authentication module 703 is configured to authenticate the identity of the first device based on the first identity authentication message, to obtain a first identity authentication result.

In some embodiments, the current device can simultaneously connect to a plurality of first devices and obtain the public key of each first device through an identifier identity key to authenticate the legitimacy of the first device.

Authenticate the identity of the first device based on the first identity authentication message to obtain the first identity authentication result, including: obtaining a public key of the first device based on the identifier of the first device. Here, the private key of the first device and the public key of the first device are identity keys of the first device; authenticating the first signature data using the public key of the first device and through a signature algorithm to obtain the first identity authentication result.

The second transmission module 701 is also configured to, in the case where the first identity authentication result is passed, send a second identity authentication message to the first device for the first device to authenticate the identity of the current device based on the second identity authentication message, to obtain a second identity authentication result.

In some embodiments, the second identity authentication message includes second signature data, and the second signature data is data obtained by signing the first random number using the private key of the current device and through a predetermined signature algorithm.

Here, the second identity authentication result includes two situations: passed and failed. Passed refers to the situation where the current device authenticates the second device as a legitimate device based on the second identity authentication message, and failed refers to the situation where the current device authenticates the second device as an illegitimate device based on the second identity authentication message.

In the case where both the first and second identity authentication results are passed, that is, both the current device and the first device successfully authenticate the identity of the other party, and then the current device and the first device can securely transmit data.

In the embodiments of the present disclosure, the second transmission module sends an identity authentication instruction to the first device, the second receiving module receives the first identity authentication message returned by the first device, and the second authentication module authenticates the identity of the first device based on the first identity authentication message returned by the first device. If the first identity authentication result is passed, the second transmission module sends a second identity authentication message to the first device, for the first device to authenticate the identity of the current device based on the second identity authentication message, thus realizing bidirectional identity authentication between the current device and the first device, avoiding illegitimate terminal device access.

In some embodiments, the second authentication module terminates the identity authentication process when the first identity authentication result is failed, in order to save network resources between the current device and the first device, and resources of the current device and the first device per se.

In some embodiments, the second receiving module is also configured to receive a second identity authentication result returned by the first device, and the current device obtains the identity authentication result on its own identity from the first device.

In some embodiments, the second receiving module is also configured to receive a message of entering the credit mode sent by the first device. Here, the first device enters the credit mode when the second identity authentication result is passed.

In some embodiments, the second receiving module is also configured to receive a message of exiting from the credit mode sent by the first device. Here, the first device sends a message of exiting from the credit mode when a number of effective communications within the preset time period is lower than a preset threshold, or sends a message of exiting from the credit mode when the current device is disconnected from the first device.

After the first device enters the credit mode, the first device cyclically monitors the number of effective communications within a preset time period. When the number of effective communications is less than the preset threshold, the first device exits from the credit mode and sends to the current device a message of the first device exiting from the credit mode.

In some embodiments of the present disclosure, the apparatus provided by the present disclosure have functions or modules that can be configured to perform the method described in the above method embodiments. The specific implementation and technical effects can refer to the description of the second aspect of the above method. For simplicity, this will not be repeated here.

In order to better understand the device identity authentication method and the device identity authentication apparatus according to the embodiments of the present disclosure, this application further introduces the device identity authentication method using the first device as the terminal device and the second device as the upper computer as examples.

As shown in FIG. 8, the device identity authentication method provided by the embodiments of the present disclosure includes the following steps.

In step S801, the upper computer sends an identity authentication instruction to the terminal device.

In step S802, the terminal device generates a first identity authentication message.

Here, the first identity authentication message includes a first random number, an identifier of the terminal device, and first signature data. Here, the identifier is an unique identifier of the terminal device identity. The terminal device obtains the first signature data by signing the first random number using the private key of the current device and through a pre agreed signature algorithm.

In step S803, the terminal device returns a first identity authentication message to the upper computer.

In step S804, the upper computer authenticates the identity of the terminal device based on the first identity authentication message, to obtain a first identity authentication result.

Obtain the public key of the first device based on its identifier; use the public key of the first device and authenticate the first signature data through a signature algorithm to obtain the first identity authentication result.

If the first identity authentication result is passed, step S805 is performed; the identity authentication process is ended when the first identity authentication result is not passed.

In step S805, the upper computer generates the second identity authentication message.

The upper computer obtains data by signing the first random number using its own private key and through a predetermined signature algorithm.

In step S806, the upper computer sends the second identity authentication message to the terminal device.

In step S807, the terminal device authenticates the identity of the upper computer based on the second identity authentication message to obtain a second identity authentication result.

Use the public key of the second device and authenticate the second signature data through an authentication algorithm to obtain the second identity authentication result. If the second identity authentication result is passed, step S808 is performed; the identity authentication process is ended when the second identity authentication result is not passed.

In step S808, the terminal device enters the credit mode.

In step S809, the terminal device returns the second identity authentication result to the upper computer.

The second authentication result can include information about the terminal device entering the credit mode.

It should be noted that the terminal device starts timing after receiving the identity authentication instruction sent by the upper computer. The subsequent steps should be completed within a preset authentication duration. If bidirectional identity authentication is not completed within the preset authentication duration, the identity authentication process ends. Here, the preset authentication duration can be set by the user, such as 2 seconds.

It should also be noted that in the embodiments of the present disclosure, different terminal devices can use the same terminal identity key, but it is preferred to use different terminal identity keys. When using different terminal identity keys, it is necessary to burn their respective identifiers and private keys to the terminal devices at the time of production, and record the correspondence between the terminal identifiers and the public keys of the identity key to form an identifier key record table. If each terminal device has a different identity key, the upper computer can obtain the public key of the identity key of the terminal device by querying the identifier key record table. Otherwise, the upper computer only needs to record and use the public key of the unified identity key of the terminal device.

Each terminal device records the same public key of the upper computer, which can authenticate the unique legitimate upper computer identity. The upper computer can obtain the public key of the identity key of each terminal device through the identifier key record table to authenticate the legitimate identity of each device.

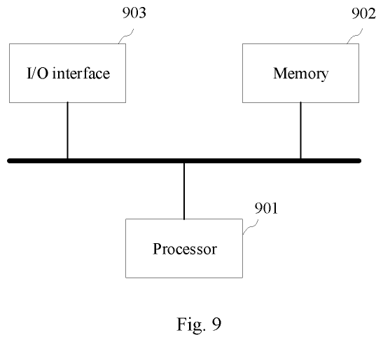

Referring to FIG. 9, the embodiments of the present disclosure provide an electronic device including:
one or more processors 901;
a memory 902, which stores one or more programs, when executed by the one or more processors, enabling the one or more processors to implement any of the device identity authentication methods mentioned above;
one or more I/O interfaces 903, connected between the processors and the memory, configured to facilitate information exchange between the processors and the memory.

Here, the processor 901 is a device with data processing capabilities, including but not limited to a central processing unit (CPU), and the like. The memory 902 is a device with data storage capability, including but not limited to a Random-access memory (RAM, more specifically SDRAM, DDR, etc.), a read-only memory (ROM), an electrically erasable programmable read-only memory (EEPROM), a flash memory (FLASH). The I/O interface (read write interface) 903 is connected between the processor 901 and the memory 902, which can implement information exchange between the processor 901 and the memory 902, including but not limited to a data bus (Bus), and the like.

In some embodiments, the processor 901, the memory 902, and the I/O interface 903 are connected to each other through a bus, thereby connecting to other components of the computing device.

This embodiment also provides a computer-readable medium on which computer programs are stored. When the program is executed by the processor, the device identity authentication method provided in the embodiments is implemented. To avoid repeated descriptions, the specific steps of the device identity authentication method will not be repeated here.

Those ordinary skilled in the art can understand that all or some steps, systems, and functional modules/units in the disclosed methods can be implemented as software, firmware, hardware, and appropriate combinations thereof. In hardware implementation, the division of functional modules/units mentioned in the above description may not necessarily correspond to the division of physical components. For example, a physical component can have multiple functions, or a function or step can be executed in collaboration with several physical components. Some or all physical components can be implemented as software executed by processors, such as central processing units, digital signal processors, or microprocessors, either as hardware or as integrated circuits, such as specialized integrated circuits. Such software can be distributed on computer readable media, which can include computer storage media (or non-transitory media) and communication media (or transitory media). As is well known to those ordinary skilled in the art, the term computer storage medium includes volatile and non-volatile, removable, and non-removable media implemented in any method or technique for storing information, such as computer-readable instructions, data structures, program modules, or other data. Computer storage media include but are not limited to RAM, ROM, EEPROM, flash memory or other storage technologies, CD-ROM, digital versatile disc (DVD) or other optical disc storage, magnetic cartridges, magnetic tapes, disk storage or other magnetic storage devices, or any other media that can be used to store desired information and can be accessed by computers. In addition, it is well known to those skilled in the art that communication media typically include computer-readable instructions, data structures, program modules, or other data in modulated data signals such as carriers or other transmission mechanisms, and may include any information delivery medium.

It should be noted that in this article, the terms “comprising”, “including”, or any other variation thereof are intended to cover non-exclusive inclusion, so that a process, a method, an article, or a device that includes a series of elements not only includes those elements, but also other elements that are not explicitly listed, or also include elements inherent in such a process, a method, an article, or a device. Without further limitations, the element limited by the statement “including a . . . ” does not exclude the existence of another identical element in the process, the method, the article, or the device that includes that element.

It can be understood that the above embodiments are only exemplary embodiments adopted to illustrate the principles of the present disclosure/utility model, however, the present disclosure/utility model is not limited to this. For those ordinary skilled in the art, various variations and improvements can be made without departing from the spirit and essence of the present disclosure/utility model, and these variations and improvements are also considered as the scope of protection of the present disclosure/utility model.

1. A device identity authentication method applied to a terminal device, comprising:
generating, by the terminal device, a first identity authentication message in response to an identity authentication instruction; wherein the identity authentication instruction is an instruction initiated by a second device to authenticate an identity of the terminal device;
sending the first identity authentication message to the second device, for the second device to authenticate the identity of the terminal device based on the first identity authentication message, to obtain a first identity authentication result;
receiving, by the terminal device, a second identity authentication message; wherein the second identity authentication message is a message sent by the second device when the first identity authentication result is passed;
authenticating an identity of the second device based on the second identity authentication message, to obtain a second identity authentication result.

2. The method according to claim 1, wherein the first identity authentication message comprises a first random number, an identifier of the terminal device, and first signature data;
wherein the first random number is generated by the terminal device, and the first signature data is obtained by signing the first random number using a private key of the terminal device and through a pre agreed signature algorithm.

3. The method according to claim 2, wherein generating a first identity authentication message in response to an identity authentication instruction comprising:
generating, by the terminal device, the first random number in response to the identity authentication instruction;
signing the first random number using the private key of the terminal device and through a pre agreed signature algorithm, to obtain the first signature data;
obtaining the first identity authentication message based on the first random number, the identifier of the terminal device, and the first signature data.

4. The method according to claim 2, wherein the second identity authentication message comprises second signature data obtained by signing the first random number using a private key of the second device and through the signature algorithm.

5. The method according to claim 4, wherein authenticating an identity of the second device based on the second identity authentication message to obtain a second identity authentication result comprising:
authenticating the second signature data using a public key of the second device and through an authentication algorithm to obtain the second identity authentication result.

6. The method according to claim 2, wherein the signature algorithm comprises either an ECDSA algorithm or an RSA algorithm.

7. The method according to claim 1, wherein after obtaining the second identity authentication result, the method further comprises:
when the second identity authentication result is authentication passed, returning a second identity authentication result to the second device.

8. The method according to claim 1, wherein after obtaining the second identity authentication result, the method further comprises:
when the second identity authentication result is authentication passed, entering, by the terminal device a credit mode; or,
when the second identity authentication result is authentication failed, generating, recording, or sending an alarm message.

9. The method according to claim 8, wherein after the terminal device entering a credit mode, the method further comprises:
cyclically monitoring a number of effective communications within a preset time period;
exiting from the credit mode when the number of effective communications is less than the preset threshold.

10. The method according to claim 8, wherein after the terminal device entering a credit mode, the method further comprises:
monitoring a connection status between the terminal device and the second device;
when the connection status is disconnected, exiting from the credit mode.

11. The method according to claim 10, wherein the terminal device and the second device are connected through a cable;
when the connection state is disconnected, exiting from the credit mode comprises:
exiting from the credit mode when the cable is disconnected from the terminal device or the second device.

12. A device identity authentication method applied to an upper computer, comprising:
sending, by the upper computer, an identity authentication instruction to a first device;
receiving a first identity authentication message returned by the first device; wherein the first identity authentication message is information generated by the first device in response to the identity authentication instruction;
authenticating an identity of the first device based on the first identity authentication message, to obtain a first identity authentication result;
when the first identity authentication result is passed, sending a second identity authentication message to the first device for the first device to authenticate an identity of the current device based on the second identity authentication message, to obtain the second identity authentication result.

13. The method according to claim 12, wherein the first identity authentication message comprises a first random number, an identifier of the first device, and first signature data; wherein the first random number is generated by the first device, and the first signature data is obtained by signing the first random number using a private key of the first device and through a pre agreed signature algorithm.

14. The method according to claim 13, wherein authenticating an identity of the first device based on the first identity authentication message to obtain a first identity authentication result comprising:
obtaining a public key of the first device based on the identifier of the first device; wherein the private key of the first device and the public key of the first device are identity keys of the first device;
authenticating the first signature data using the public key of the first device and through the signature algorithm, to obtain the first identity authentication result.

15. The method according to claim 13, wherein the second identity authentication message comprises second signature data obtained by signing the first random number using a private key of the upper computer and through a predetermined signature algorithm.

16. The method according to claim 13, wherein the signature algorithm comprises either an ECDSA algorithm or an RSA algorithm.

17. The method according to claim 12, wherein the first device is authenticated based on the first identity authentication message, and after obtaining the first identity authentication result, the method further comprises:
when the first identity authentication result is failed, terminating the identity authentication process.

18. The method according to claim 12, wherein after sending a second identity authentication message to the first device, the method further comprises:
receiving the second identity authentication result returned by the first device.

19. The method according to claim 12, wherein after sending a second identity authentication message to the first device, the method further comprises:
receiving a message of entering a credit mode sent by the first device; wherein the first device enters the credit mode when the second identity authentication result is passed.

20.-22. (canceled)

23. An electronic device comprising:
one or more processors;
a storage device on which one or more programs are stored, when the one or more programs are executed by the one or more processors, such that the one or more processors implement the method according to claim 1;
one or more I/O interfaces connected between the processor and the memory, configured to implement information exchange between the processor and the memory.

24. (canceled)
